(19) United States
(12) Patent Application Publication
(10) Pub. No.: US 2025/0322075 A1
(43) Pub. Date: Oct. 16, 2025

(54) SYSTEMS AND METHODS FOR IDENTIFYING SECURITY THREATS

(71) Applicant: Google LLC, Mountain View, CA (US)

(72) Inventor: Rishi Kishore Verma, Bangalore (IN)

(21) Appl. No.: 18/631,459

(22) Filed: Apr. 10, 2024

(51) Int. Cl. G06F 21/57

(52) U.S. Cl. CPC G06F 21/577

(57) ABSTRACT

Methods and systems for identifying security threats are provided herein. A plurality of records each corresponding to respective one or more events associated with a set of computing resources is received. For each of the plurality of records, a level of confidence that a respective record is indicative of a security threat is determined using a trained artificial intelligence (AI) model. Responsive to determining that a level of confidence of a first record satisfies a first threshold criterion, the first record is forwarded to a security threat detection platform. Responsive to determining that a level of confidence of each of a second record and a third record fails to satisfy the first threshold criterion but satisfies a second threshold criterion, the second record is aggregated with the third record to create aggregated data and at least part of the aggregated data is forwarded to the security threat detection platform.

### TECHNICAL FIELD

Aspects and implementations of the present disclosure relate to computer security, and, in particular, to providing systems and methods for identifying security threats.

### BACKGROUND

Computing resources such as data centers, client devices, and cloud computing platforms may be susceptible to security threats (e.g., malware, network-based attacks). Security threats can lead to interruption or inefficient operation of computing resources, which can be problematic for owners and operators of computing resources. In extreme cases, security threats can damage computing resources or data stored thereon, potentially causing substantial financial loss and other losses and liabilities for the owners and operators of computing resources.

Security platforms typically have security threat notification mechanisms in place that alert clients when potential security threats are detected. The security threat can then be mitigated, e.g., by blocking an intrusive file from being downloaded, stopping intrusive processes that are running, etc. Detection engineering in security platforms is often a manual and time-consuming process for security professionals, involving analyzing a vast amount of data (e.g., logs) generated at computing resources, which can result in human errors and strain the human resources of security teams.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a method is disclosed for identifying security threats. The method includes receiving a plurality of records each corresponding to respective one or more events associated with a set of computing resources of one or more entities. The method further includes, for each of the plurality of records, determining, using a trained artificial intelligence (AI) model, a level of confidence that a respective record is indicative of a security threat. The method further includes, responsive to determining that a level of confidence of a first record of the plurality of records satisfies a first threshold criterion: forwarding the first record to a security threat detection platform. The method further includes, responsive to determining that a level of confidence of each of a second record and a third record of the plurality of records fails to satisfy the first threshold criterion but satisfies a second threshold criterion: aggregating the second record with the third record to create aggregated data and forwarding at least part of the aggregated data to the security threat detection platform.

In some embodiments, each of the plurality of records is received by a forwarder agent running on a computing resource of a respective set of computing resources. In some embodiments, each of the plurality of records is received by a filtering component from a forwarder agent running on a computing resource of a respective set of computing resources.

In some embodiments, a level of confidence of a record satisfies the first threshold criterion when the level of confidence of the record is above a first threshold associated with the first threshold criterion. In some embodiments, a level of confidence of a record satisfies the second threshold criterion when the level of confidence of the record is above a second threshold associated with the second threshold criterion, wherein the first threshold is higher than the second threshold.

In some embodiments, to determine, using the trained AI model, the level of confidence that the respective record is indicative of the security threat, the method further includes providing the respective record as input to the trained AI model and obtaining, from the trained AI model one or more outputs specifying the level of confidence that the respective record is indicative of the security threat.

In some embodiments, the method further includes generating a training input based on a set of historical records of a plurality of historical events associated with a plurality of computing resources. The method further includes generating a target output for the first training input, wherein the first target output identifies whether each historical record of the plurality of historical records is indicative of a respective security threat. The method further includes utilizing training data comprising the training input and the target output for re-training the trained AI model.

In some embodiments, to generate the first training input, the method further includes splitting a historical record of the set of historical records into one or more tokens.

In some embodiments, to generate the first training input, the method further includes transforming each token referenced in a historical record of the set of historical records into one or more stems.

In some embodiments, to generate the first training input, the method further includes transforming each token referenced in a historical record of the set of historical records into one or more lemmas.

In some embodiments, to generate the first training input, the method further includes discarding one or more tokens from a historical record of the set of historical records.

In some implementations, a system is disclosed. The system includes a memory and a processing device. The processing device is to perform operations including receiving a plurality of records each corresponding to respective one or more events associated with a set of computing resources of one or more entities. The operations further include, for each of the plurality of records, determining, using a trained artificial intelligence (AI) model, a level of confidence that a respective record is indicative of a security threat. The operations further include, responsive to determining that a level of confidence of a first record of the plurality of records satisfies a first threshold criterion: forwarding the first record to a security threat detection platform. The operations further include, responsive to determining that a level of confidence of each of a second record and a third record of the plurality of records fails to satisfy the first threshold criterion but satisfies a second threshold criterion: aggregating the second record with the third record to create aggregated data and forwarding at least part of the aggregated data to the security threat detection platform.

In some embodiments, each of the plurality of records is received by a forwarder agent running on a computing resource of a respective set of computing resources. In some embodiments, each of the plurality of records is received by a filtering component from a forwarder agent running on a computing resource of a respective set of computing resources.

In some embodiments, a level of confidence of a record satisfies the first threshold criterion when the level of confidence of the record is above a first threshold associated with the first threshold criterion. In some embodiments, a level of confidence of a record satisfies the second threshold criterion when the level of confidence of the record is above a second threshold associated with the second threshold criterion, wherein the first threshold is higher than the second threshold.

In some embodiments, to determine, using the trained AI model, the level of confidence that the respective record is indicative of the security threat, the operations further include providing the respective record as input to the trained AI model and obtaining, from the trained AI model one or more outputs specifying the level of confidence that the respective record is indicative of the security threat.

In some embodiments, the operations further include generating a training input based on a set of historical records of a plurality of historical events associated with a plurality of computing resources. The operations further include generating a target output for the first training input, wherein the first target output identifies whether each historical record of the plurality of historical records is indicative of a respective security threat. The operations further include utilizing training data comprising the training input and the target output for re-training the trained AI model.

In some embodiments, to generate the first training input, the operations further include splitting a historical record of the set of historical records into one or more tokens.

In some embodiments, to generate the first training input, the operations further include transforming each token referenced in a historical record of the set of historical records into one or more stems.

In some embodiments, to generate the first training input, the operations further include transforming each token referenced in a historical record of the set of historical records into one or more lemmas.

In some embodiments, to generate the first training input, the operations further include discarding one or more tokens from a historical record of the set of historical records.

### BRIEF DESCRIPTION OF DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 depicts a flow diagram of an example method for identifying security threats, in accordance with implementations of the present disclosure.

FIG. 3 illustrates an example predictive system, in accordance with implementations of the present disclosure.

FIG. 4 depicts a flow diagram of a method for training an AI model, in accordance with implementations of the present disclosure.

FIG. 5 is a block diagram illustrating an exemplary computer system, in accordance with implementations of the present disclosure.

### DETAILED DESCRIPTION

Aspects of the present disclosure relate to providing systems and methods for identifying security threats. In some instances, a security platform (e.g., a security threat detection platform) can provide resources or services associated with monitoring activity of one or more client devices of a cloud-based environment to detect a security threat and, in some instances, act in response to a detected security threat. For example, a user (e.g., an enterprise user) can provide the platform with access to event logs (e.g., log records) from client devices of the user's cloud-based environment. One or more computing systems of the security platform can apply security rules (e.g., defined by the user and/or the security platform) to events of the event logs in order to determine whether a security threat has occurred, and, in some instances, which actions should be taken to address the security threat.

In some security platforms, upon determining that a security threat has occurred (e.g., based on the comparison of the security threat to the security rules), a computing system can forward an event log indicative of the security threat to one or more first-tier analysts (e.g., analysis modules associated with the security platform, etc.). In some instances, a first-tier analyst can evaluate the event log to determine whether the security threat is a probable security threat (e.g., indicative of an actual security breach) and, if so, forward the event log to a second-tier analyst (e.g., another analyst module of the platform, etc.) to determine what type of action should be taken to address the security threat. In some instances, the second-tier analyst forwards the alert to a third-tier analyst (e.g., another analyst module of the platform, etc.), which may be specialized in actions taken to address the specific type of security threat.

In some instances, a computing system can produce a significant number of event logs, many of which may not be actual security threats and, therefore, do not need to be escalated to a second-tier or third-tier analyst for action. Such alerts can consume a large amount of system time and resources. For instance, it can take a significant amount of time, and therefore a large amount of computing resources, for a first-tier analyst to evaluate each event log issued by the platform and determine whether the event log should be escalated to a second-tier and/or third-tier analyst, or if the event log can be disregarded. Such computing resources are, therefore, unavailable for other processes of the system, which can increase the overall latency and decrease the overall efficiency of the system. Further, as malicious actors become increasingly sophisticated, it can become increasingly difficult for first-tier analysts to accurately determine whether an event log is a probable security threat and for second-tier and/or third-tier analysts to quickly identify appropriate actions to be taken to address the probable security threat. This further increases the risk of a serious security incident in a cloud-based environment.

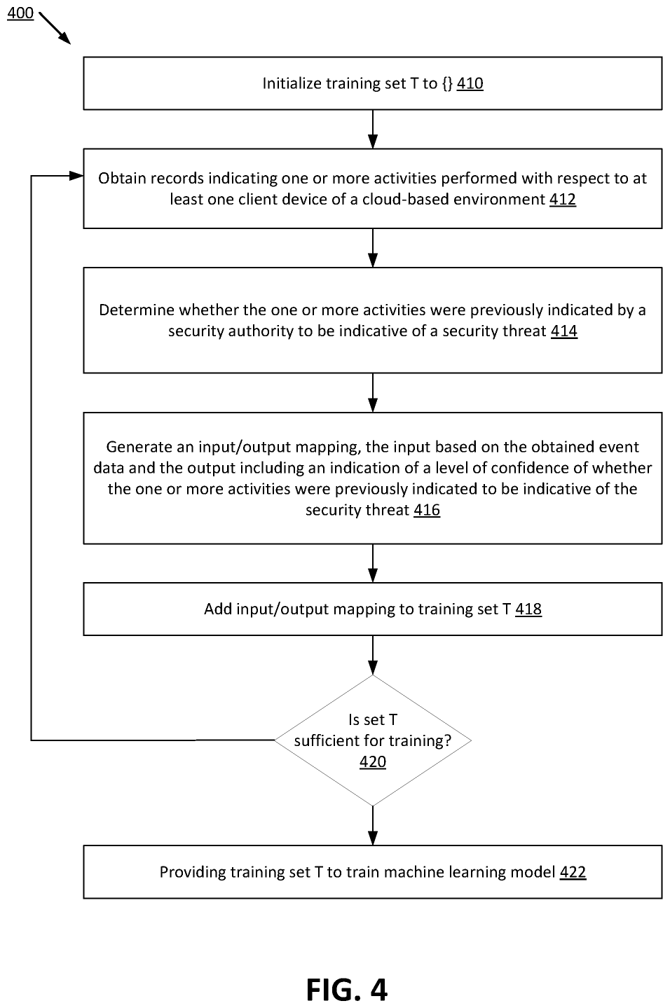

Embodiments of the present disclosure address the above and other deficiencies by providing artificial intelligence (AI) and/or machine learning techniques for identifying security threats in a cloud-based environment. A platform (also referred to herein as a “security threat detection platform” or “security platform”) can maintain or otherwise have access to one or more AI models associated with security threat detection in a cloud-based environment. In some embodiments, the one or more AI models can be trained to determine whether a log record corresponding to log records (e.g., event logs) reflecting events (e.g., state changes) caused by actions performed with respect to and/or by one or more client devices of a cloud-based environment is indicative of a security threat. In some embodiments, the one or more AI models can be trained based on historical log records collected for client devices of the cloud-based environment. Further details regarding training the AI model(s) are provided with respect to FIG. 4 below.

In some embodiments, multiple client devices of the cloud-based environment can provide the platform with log records that reflect events (e.g., state changes) caused by actions performed with respect to and/or by the client devices. The actions can include processing actions (e.g., the type or frequency of operations performed at a client device), data access actions (e.g., a type or frequency of data accessed by the client device), network-based actions (e.g., entities that transmit or receive data from the client device, a frequency of transmission to such entities, etc.), and so forth. The platform can feed the log records as input to one or more AI models and can obtain one or more outputs. In some embodiments, the outputs can specify a level of confidence of a given subset of log records being indicative of a security threat.

The levels of confidence can be utilized for triaging the log records. In an illustrative example, the subsets of log records associated with levels of confidence satisfying a high threshold criterion (e.g., exceeding a predefined high threshold value) can be forwarded to the security platform for analysis. Conversely, the subsets of log records associated with levels of confidence failing a low threshold criterion (e.g., falling below a predefined low threshold value) can be discarded, thus alleviating the load onto the security platform. In some implementations, the subsets of log records associated with levels of confidence failing the high threshold criterion but satisfying the low threshold criterion (e.g., exceeding the low threshold value while falling below the high threshold value) can be aggregated with other similar subsets of log records to produce an aggregated subset of log records, which then can be forwarded to the security platform for analysis. Aggregating the subsets of log records is thus another mechanism for alleviating the load onto the security platform.

Aspects and embodiments of the present disclosure enable detection of security threats in a cloud-based environment using AI techniques. As described above, embodiments of the present disclosure provide AI models that are trained to determine whether client device events are indicative of security threats in a cloud-based environment. A platform can accordingly identify events that are indicative of probable security threats and filter event logs based on the outputs of the AI model(s). Thus, the platform can identify events that correspond to probable security threats in a shorter amount of time, which reduces the amount of computing resources consumed in the cloud-based environment (e.g., which improves the overall efficiency and decreases the overall latency of the system) and minimizes the amount of time that resources of the cloud-based environment are exposed to security threats.

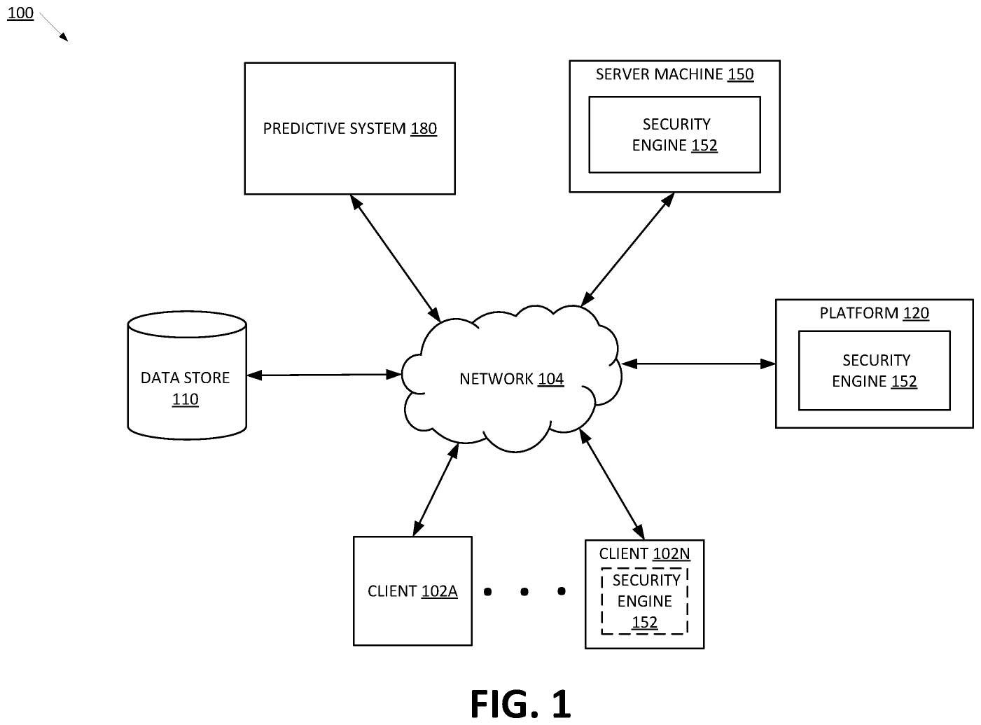

FIG. 1 illustrates an example system architecture 100, in accordance with implementations of the present disclosure. The system architecture 100 (also referred to as “system” herein) includes client devices 102A-N (collectively and individually referred to as client device 102 herein), a data store 110, a platform 120, server machine 150, and/or a predictive system 180 each connected to a network 104. In implementations, network 104 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. In some embodiments, system 100 can be or otherwise include a cloud-based computing environment (also referred to as a “cloud-based environment” herein).

In some implementations, data store 110 is a persistent storage that is capable of storing data as well as data structures to tag, organize, and index the data. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 104.

Platform 120 can be configured to monitor activity of one or more client devices of system 100 and detect whether a security threat has occurred based on the monitored activity. In some embodiments, platform 120 can additionally or alternatively determine one or more security actions to be performed in response to the security threat. A client device refers to a device that communicates with other devices across a network (e.g., network 104). In some embodiments, client devices 102 can be or otherwise include an endpoint device. In other or similar embodiments, client devices 102 can be connected to one or more endpoint devices (e.g., via network 104). As illustrated in FIG. 1, platform 120 can include a security engine 152. Security engine 152 can be configured to detect a security threat, in accordance with embodiments described herein.

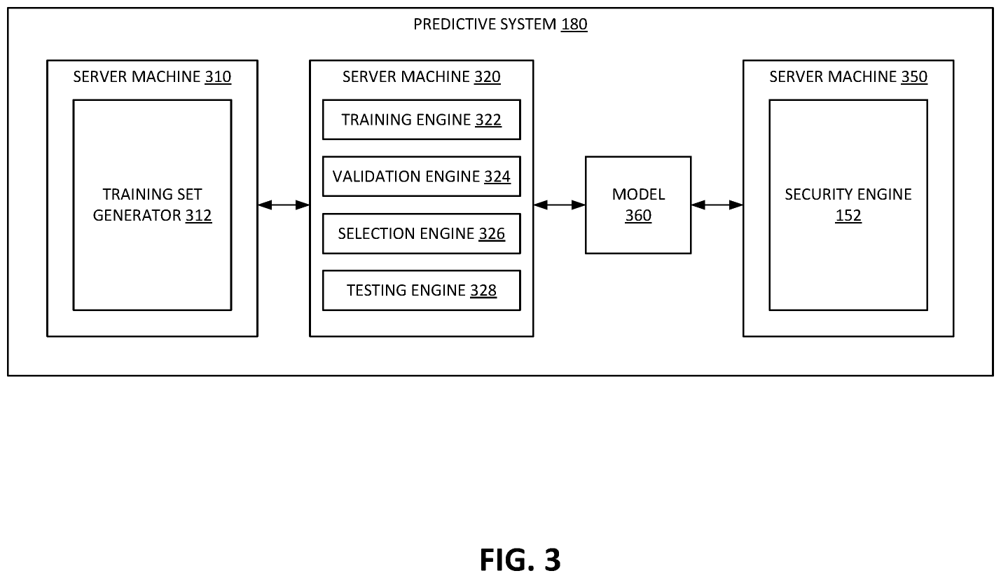

In some embodiments, security engine 152 can detect a security threat based on one or more outputs of an artificial intelligence (AI) model. An AI model can include a generative AI model, a discriminative AI model, or any other type of AI model that can be trained to provide predictions. In some embodiments, one or more AI models can be trained to determine a level of confidence that a respective subset of log records is indicative of a security threat. Further details regarding the AI model are provided with respect to FIG. 3 below.

In some embodiments, predictive system 180 can train the AI model based on historical log records collected for client devices 102 of system 100 (or other cloud-based environments). In an illustrative example, predictive system 180 can train an AI model based on training data that includes a set of training inputs, such that each training input is associated with a corresponding target output. A training input may include a subset of log records reflecting events associated with one or more client devices 102 of system 100. The corresponding target output may indicate whether the subset of log records is indicative of a security threat. For example, the corresponding target output may be a binary response indicating a “yes” or “no” response to whether the subset of log records is indicative of a security threat. In another example, the corresponding target output may specify a level of confidence that the subset of log records is indicative of a security threat. In some embodiments, the level of confidence can be measured on a particular confidence scale. The confidence scale can be preselected by the platform 120 and/or the client devices 102. In some embodiments, the confidence scale can be one of the following non-exhaustive types of confidence scales: a numeric scale, a percentage scale, an interval scale, a qualitative scale, etc. A numeric scale can assign a numerical value to indicate a confidence level. For example, a numeric scale can be a scale of 1 to 10, where 1 represents a low confidence level and 10 represents a high confidence level. A percentage scale can assign a percentage value to indicate a confidence level. For example, a percentage scale can be a scale of 0% to 100%, where 0% indicates the lowest confidence level and 100% represents the highest confidence level. An interval scale can be a scale that includes a range of confidence levels divided into equal intervals. A qualitative scale can be used to qualitatively express a confidence level, such as a “low” confidence level, a “medium” confidence level, a “high” confidence level, etc. Further details regarding predictive system 180 and training the AI model are provided with respect to FIGS. 3-4 below.

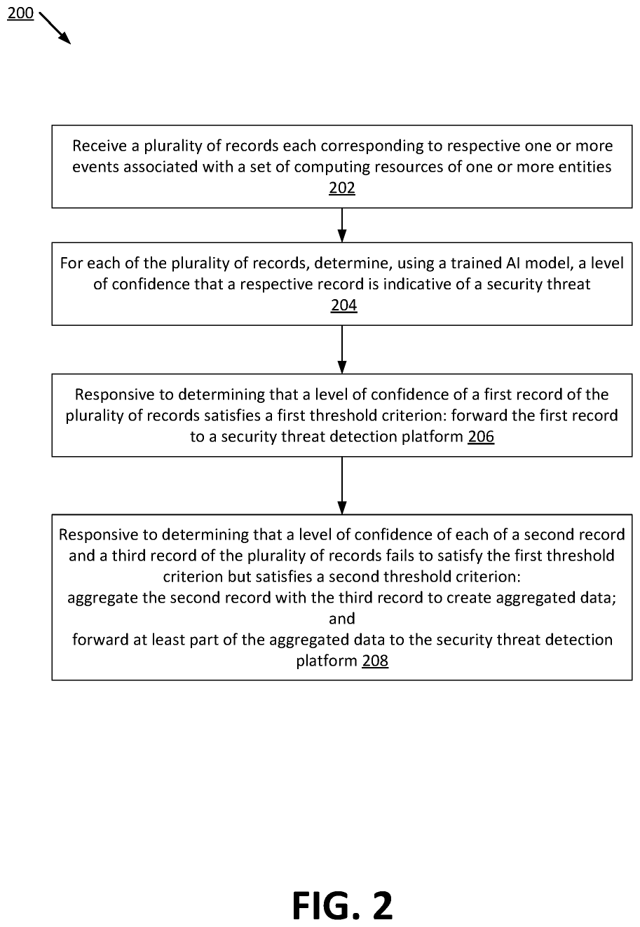

Security engine 152 (e.g., residing at platform 120 and/or server machine 150) can feed log records obtained from one or more client devices as input to AI model(s) and can determine, for a specified subset including one or more log records, a confidence level that a respective log record is indicative of a security threat based on one or more outputs of the model(s), as described herein. Further details are provided herein with respect to FIGS. 2-3.

Although FIG. 1 illustrates security engine 152 as part of platform 120, in additional or alternative embodiments, security engine 152 can reside on one or more server machines that are remote from platform 120. For example, security engine 152 can reside at server machine 150. In other or similar embodiments, security engine 152 can reside on one or more client devices 102. For example, security engine 152 can reside at a client device 102N, as illustrated in FIG. 1. Further, although FIG. 1 illustrates predictive system 180 as remote from platform 120, in additional or alternative embodiments, predictive system 180 can reside on platform 120, server machine(s) 150, client device 102, and/or any other component of system 100. It should be noted that in some other implementations, the functions of platform 120, server machine 150, and/or predictive system(s) 180 can be provided by more or a fewer number of machines. For example, in some implementations, components and/or modules of platform 120, server machine 150, and/or predictive system(s) 180 may be integrated into a single machine, while in other implementations components and/or modules of any of platform 120, server machine 150, and/or predictive system(s) 180 may be integrated into multiple machines. In addition, in some implementations, components and/or modules of server machine 150, and/or predictive system(s) 180 may be integrated into platform 120.

In general, functions described in implementations as being performed platform 120, server machine 150, and/or predictive system(s) 180 can also be performed on the client device 102 in other implementations. In addition, the functionality attributed to a particular component can be performed by different or multiple components operating together. Platform 120 can also be accessed as a service provided to other systems or devices through appropriate application programming interfaces, and thus is not limited to use in websites.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 depicts a flow diagram of an example method 200 for identifying security threats, in accordance with implementations of the present disclosure. Method 200 can be performed by processing logic that can include hardware (circuitry, dedicated logic, etc.), software (e.g., instructions run on a processing device), or a combination thereof. In one implementation, some or all of the operations of method 200 can be performed by one or more components of system 100 of FIG. 1. In some embodiments, some or all of the operations of method 200 can be performed by security engine 152, as described above.

At block 202, the processing logic receives a set of logs records (also referred to herein as “records”). Each log record can correspond to one or more events associated with a set of computing resources of one or more entities (e.g., client device 102 of FIG. 1). The set of log records reflects events (e.g., state changes) caused by actions performed by a respective client device and/or with respect to the set of client devices. In some embodiments, a forwarder argent running on a computing resource of the set of computing resources can receive the set of log records from one or more client devices 102. In some embodiments, a filtering component from a forwarder agent running on a computing resource of the set of computing resources can receive the set of log records from one or more client devices 102. In some embodiments, the set of log records can indicate processing actions (e.g., a type or frequency of operations performed at or with respect to a client device), data access actions (e.g., a type or frequency of data accessed by the client device, transmitted by the client device 102, and/or transmitted from the client device 102), network-based actions (e.g., entities that transmit or receive data from the client device, a frequency of transmission to such entities), and so forth.

In some embodiments, security engine 152 can transmit a set of instructions to a client device 102 that, when executed, cause the client device 102 to generate a log record reflecting one or more events (e.g., state changes) caused by one or more actions performed with respect to and/or by the client device 102. Security engine 152 can transmit the set of instructions to client device 102 during an initialization process associated with system 100, in some embodiments. Client device 102 can generate the log record according to a schedule or protocol indicated by the set of instructions and can transmit the generated log record as a log record of the set of log records.

In some embodiments, multiple client devices 102 can be associated with a common user (e.g., an enterprise user). For example, multiple client devices 102 can be associated with a common organization or entity. An administrator of the organization or entity can enroll each of the multiple client devices 102 for security monitoring by security engine 152 and/or platform 120. some embodiments, security engine 152 can transmit the set of instructions to each of the multiple client devices 102 (e.g., during an initialization process). Accordingly, each of the multiple client devices 102 can transmit the set of log records to platform 120. In some embodiments, platform 120 can receive multiple sets of log records each transmitted by a respective client device 102 associated with the organization or entity in a time period.

At block 204, the processing logic determines, for a specified subset including one or more log records, using a trained artificial intelligence (AI) model, a level of confidence that a respective log record is indicative of a security threat. For example, the processing logic can feed the specified subset of log records as input to an AI model. In some embodiments, the AI model can be trained to determine, for a specified subset including one or more log records, a level of confidence that a respective log record of the set of log records is indicative of a security threat. For example, the processing logic can obtain one or more outputs of the AI model. The one or more outputs can indicate a level of confidence that a respective log record is indicative of a security threat.

The subset of log records can be selected based on a chosen time window. For example, the processing logic can identify log records having their respective time stamps within the chosen time window. In some embodiments, the time window can be specified by the security engine 152 and/or platform 120. For example, a time window can be every minute, hour, day, etc. Additionally, or alternatively, the processing logic can select the subset of log records based on a set of filtering conditions. The set of filtering conditions can specify one or more application names, one or more error codes, one or more keywords, etc. In some embodiments, the one or more application names, one or more error codes, one or more keywords, etc., can be specified by the security engine 152 and/or platform 120. For example, the processing logic can identify an application name included in a log record, where the application name can be the name of a software program and/or application at which an action causing an event reflected in the log record is performed. In response to selecting the subset of log records, the processing logic can feed the subset of log records as input to the AI model. In response to feeding the subset of log records as input to the AI model, the processing logic can obtain one or more outputs of the AI model, where the one or more outputs can indicate a level of confidence that the respective subset of log records is indicative of a security threat. In some embodiments, the AI model can be trained (e.g., by predictive system 180) based on historical log records collected from one or more client devices 102 of system 100 (and/or another cloud-based environment). Further details regarding training the AI model are provided with respect to FIGS. 3-4 below.

At block 206, in response to determining that a level of confidence of a log record (e.g., a first log record) of the set of log records satisfies a threshold criterion (e.g., a first threshold criterion), the processing logic forwards the first log record to a security threat detection platform. In some embodiments, the processing logic can determine that the level of confidence of the first log record satisfies the first threshold criterion using the one or more outputs obtained from the AI model, where the one or more outputs indicate the level of confidence of the first log record. In response to obtaining the one or more outputs indicating the level of confidence of the first log record, the processing logic can compare the level of confidence to a threshold (e.g., a first threshold) associated with the first threshold criterion. In response to determining that the level of confidence of the first log record is above the first threshold, the processing logic can determine that the level of confidence of the first log record satisfies the first threshold criterion, where satisfying the first threshold criterion is indicative of there being a high likelihood that the first log record is indicative of a security threat.

At block 208, in response to determining that a level of confidence of each of a second log record and a third log record of the set of log records fails to satisfy the first threshold criterion but satisfies another (e.g., a second) threshold criterion, the processing logic aggregates the second log record with the third log record to create aggregated data and forwards at least part of the aggregated data to the security threat detection platform. The processing logic can create the aggregated data using a clustering model (e.g., a machine learning density-based clustering model). For example, the clustering model can group log records together in a cluster based on a similar level of confidence of each log record (e.g., levels of confidence that are in between the first threshold and the second threshold).

Additionally, or alternatively, the processing logic can group log records together into a subset of log records based on one or more of the set of filtering conditions. For example, each log record included in a particular subset of log records can include a same or similar application name, a same or similar error code, a same or similar keyword, etc. The processing logic can compare the application name included in the log record to the one or more application names specified by the set of filtering conditions. If the processing logic determines a match between the application name included in the log record and the one or more application names specified by the set of filtering conditions, the processing logic can group the log record into a particular subset of log records, where each log record included in the particular subset of log records includes the same or similar application name. In another example, the processing logic can identify an error code included in a log record, where the error code can indicate an error associated with performing an action causing an event reflected in the log record. The processing logic can compare the error code included in the log record to the one or more error codes specified by the set of filtering conditions. If the processing logic determines a match between the error code included in the log record and the one or more error codes specified by the set of filtering conditions, the processing logic can group the log record into a particular subset of log records, where each log record included in the particular subset of log records includes the same or similar error code. In another example, the processing logic can identify a keyword included in a log record, where the keyword can pertain to one or more characteristics of the log record and/or event reflected by the log record. For example, the keyword can indicate a type of event reflected by the log record, a type of action performed that caused the event reflected by the log record, etc. The processing logic can compare the keyword included in the log record to the one or more keywords specified by the set of filtering conditions. If the processing logic determines a match between the keyword included in the log record and the one or more keywords specified by the set of filtering conditions, the processing logic can group the log record into a particular subset of log records, where each log record included in the particular subset of log records includes the same or similar keywords. Each filtering condition can be set by the security engine 152 and/or platform 120.

In some embodiments, to create the aggregated data, the processing logic can select, among each subset of log records, one or more subsets of log records (e.g., a first grouping of subsets of log records) that have the highest level of confidence compared to other subsets of log records. In some embodiments, the processing logic can identify, among each subset of log records, one or more other subsets of log records (e.g., a second grouping of subsets of log records) that satisfy one or more predefined rules (e.g., with respect to timestamps, network addresses, etc.). For example, the processing logic can identify one or more subsets of log records, where each log record included in each of the one or more subsets of log records having their timestamps falling within a predefined time window. In another example, the processing logic can identify one or more subsets of log records, where each log record included in each of the one or more subsets of log records is associated with the same network address or with the same group of network addresses. The processing logic can aggregate the identified second grouping of subsets of log records with the first grouping of subsets of log records to create the aggregated data (e.g., using the clustering model described above).

In some embodiments, the processing logic can determine that the level of confidence of the second log record and the third log record fails to satisfy the first threshold criterion but satisfies the second threshold criterion using the one or more outputs obtained from the AI model, where the one or more outputs indicate the level of confidence of each of the second log record and the third log record. In response to obtaining the one or more outputs indicating the level of confidence of each of the second log record and the third log record, the processing logic can compare the level of confidence of each of the second log record and the third log record to the first threshold associated with the first threshold criterion. In response to determining that the level of confidence of each of the second log record and the third log record is below the first threshold, the processing logic can compare the level of confidence of each of the second log record and the third log record to another (e.g., a second) threshold associated with the second threshold criterion. In response to determining that the level of confidence of each of the second log record and the third log record is above the second threshold, the processing logic can determine that the level of confidence of each of the second log record and the third log record fails to satisfy the first threshold criterion but satisfies the second threshold criterion, where satisfying the second threshold criterion is indicative of the first log record more than likely being indicative of a security threat.

In some embodiments, in response to determining that the level of confidence of another (e.g., a fourth) log record of the set of log records fails to satisfy the first threshold criterion (e.g., is less than the first threshold) and fails to satisfy the second threshold criterion (e.g., is less than the second threshold), the processing logic can determine that the fourth log record is less than likely (e.g., there is a low likelihood) to be indicative of a security threat. In response to determining that the level of confidence of the fourth log record fails to satisfy the first threshold criterion and the second threshold criterion, the processing logic can refrain from forwarding the fourth log record to the security threat detection platform.

In some embodiments, the first threshold criterion and the second threshold criterion can be defined by a developer or operator of platform 120 and/or determined based on experimental or historical data associated with system 100. For example, the first threshold criterion and the second threshold criterion can be selected to achieve a desired degree of reduction of the volume of data that is sent to the security platform for security analysis (e.g., by refraining from sending to the security platform any log records of events that are not likely to be indicative of a security threat (e.g., the level of confidence of the log record is less than the second threshold), while not discarding any data likely to be indicative of serious security threats (e.g., the level of confidence of the log record is above the first threshold). A log record having a level of confidence between the low and high thresholds can be aggregated with other log records having similar levels of confidence into aggregated data, thus also reducing the volume of data that is sent to the security platform for security analysis (e.g., by reducing the amount of log records being sent to the security platform).

In some embodiments, in response to forwarding a log record and/or the aggregated data to the security threat detection platform, the security threat detection platform can perform security analysis of the log record and/or the aggregated data (e.g., to take action and/or mitigate the security threat).

FIG. 3 illustrates an example predictive system 180, in accordance with implementations of the present disclosure. In some embodiments, predictive system 180 can be configured to train one or more AI models 360 associated with security engine 152.

As illustrated in FIG. 3, predictive system 180 can include a training set generator 312 (e.g., residing at server machine 310), a training engine 322, a validation engine 324, a selection engine 326, and/or a testing engine 328 (e.g., each residing at server machine 320), and/or a predictive component (e.g., residing at server machine 350). Training set generator 312 may be capable of generating training data (e.g., a set of training inputs and a set of target outputs) to train model 360. In some embodiments, the predictive component residing at server machine 350 can be or otherwise include security engine 151.

As mentioned above, training set generator 312 can generate training data for training model 360. Training set generator 312 can obtain training data for training model 360 and can organize or otherwise group the training data for training model 360 (e.g., according to the purpose of the model).

FIG. 4 depicts a flow diagram of a method 400 for training an AI model, in accordance with implementations of the present disclosure. Method 400 can be performed by processing logic that can include hardware (circuitry, dedicated logic, etc.), software (e.g., instructions run on a processing device), or a combination thereof. In one implementation, some or all of the operations of method 400 can be performed by one or more components of system 100 of FIG. 1. In some embodiments, some or all of the operations of method 400 can be performed by predictive system 180, specifically by training set generator 312 of predictive system 180.

Referring now to FIG. 4, at block 410, processing logic initializes training set T to null (e.g., { }). At block 412, processing logic obtains historical log records (e.g., event logs) reflecting one or more events (e.g., state changes) caused by actions performed with respect to and/or by at least one client device of a cloud-based environment. In some embodiments, the historical log records can indicate processing actions (e.g., a type or frequency of operations performed at or with respect to a client device), data access actions (e.g., a type or frequency of data accessed by the client device, transmitted by the client device 102, and/or transmitted from the client device 102), network-based actions (e.g., entities that transmit or receive data from the client device, a frequency of transmission to such entities), and so forth. In some embodiments, the processing logic can split each historical log record of the set of historical log records into one or more tokens. For example, the processing logic can use tokenization to split a historical log record into one or more tokens, where the characters in a historical log record are split based on specific delimiters and/or patterns, where the specific delimiters and/or patterns can be specified by a security threat detection platform. In some embodiments, in response to splitting each historical log record into the one or more tokens, the processing logic can transform each token of the one or more tokens into one or more stems. For example, the processing logic can use stemming to transform each token into one or more stems (e.g., a root or base form of a word). In some embodiments, in response to splitting each historical log record into the one or more tokens, the processing logic can transform each token of the one or more tokens into one or more lemmas. For example, the processing logic can use lemmatization to transform each token into one or more lemmas (e.g., a base or dictionary form of a word). In some embodiments, the processing logic can discard one or more tokens from a historical log record. For example, the processing logic can determine, based on one or more rules specified by a security threat detection platform, that a token of the one or more tokens is a rudimentary word and/or phrase that is inconsequential to security analysis. In response, the processing logic can discard the token from the historical log record.

At block 414, processing logic determines whether the one or more actions were previously indicated by a security authority to be indicative of a security breach.

In some embodiments, one or more of the actions of the log records may have been involved or lead to a security threat of which a security authority (e.g., a security analyst) took a security action to address the security threat. Such actions may be indicated in logs associated with the cloud-based environment and/or platform 120. Processing logic can identify the logs (e.g., from memory 250 or from another memory associated with the cloud-based environment) and can determine one or more actions that prompted a security action by the security authority.

At block 416, processing logic generates an input/output mapping, the input based on the obtained log records and the output including an indication of a level of confidence whether the one or more actions were previously indicated to be indicative of a security threat. In some embodiments, the output may be a binary response indicating a “yes” or “no” response to whether the subset of log records is indicative of a security threat. In another example, the output may specify a level of confidence that the subset of log records is indicative of a security threat. In some embodiments, the level of confidence can be measured on a particular confidence scale. The confidence scale can be preselected by the platform 120 and/or the client devices 102. In some embodiments, the confidence scale can be one of the following non-exhaustive types of confidence scales: a numeric scale, a percentage scale, an interval scale, a qualitative scale, etc. A numeric scale can assign a numerical value to indicate a confidence level. For example, a numeric scale can be a scale of 1 to 10, where 1 represents a low confidence level and 10 represents a high confidence level. A percentage scale can assign a percentage value to indicate a confidence level. For example, a percentage scale can be a scale of 0% to 100%, where 0% indicates the lowest confidence level and 100% represents the highest confidence level. An interval scale can be a scale that includes a range of confidence levels divided into equal intervals. A qualitative scale can be used to qualitatively express a confidence level, such as a “low” confidence level, a “medium” confidence level, a “high” confidence level, etc.

At block 418, processing logic adds the input/output mapping to training set T. At block 420, processing logic determines whether training set T is sufficient for training. Processing logic can determine whether training set T is sufficient for training by determining whether a number of input/output mappings of training set T meets or exceeds a threshold number of mappings. In some embodiments, processing logic can determine whether the training set T is sufficient for training determining whether the training set T contains a balanced representation of events that have a low likelihood of being indicative of a security threat and a high likelihood of being indicative of a security threat, thus decreasing the likelihood of false negatives. In response to determining that the training set T does not contain a balanced representation, the processing logic can modify the training set T to include a balanced representation of events that have a low likelihood of being indicative of a security threat and a high likelihood of being indicative of a security threat. Upon processing logic determining that training set T is insufficient for training, method 400 can return to block 412. Upon processing logic determining that training set T is sufficient for training, method 400 can proceed to block 422. At block 422, processing logic provides training set T to train or re-train the AI model.

Referring to FIG. 3, in some embodiments, processing logic can provide training set T to training engine 322 to train or re-train the AI model. For example, training engine 322 can train or re-train an AI model 360 using the training data (e.g., training set T) from training set generator 312. The AI model 360 can refer to the model artifact that is created by the training engine 322 using the training data that includes training inputs and/or corresponding target outputs (correct answers for respective training inputs). The training engine 322 can find patterns in the training data that map the training input to the target output (the answer to be predicted), and provide the AI model 360 that captures these patterns. The AI model 360 can be composed of, e.g., a single level of linear or non-linear operations (e.g., a support vector machine (SVM or may be a deep network, i.e., an AI model that is composed of multiple levels of non-linear operations). An example of a deep network is a neural network with one or more hidden layers, and such an AI model may be trained by, for example, adjusting weights of a neural network in accordance with a backpropagation learning algorithm or the like. In one aspect, the training set is obtained by training set generator 312 hosted by server machine 310.

Validation engine 324 may be capable of validating a trained AI model 360 using a corresponding set of features of a validation set from training set generator 312. The validation engine 324 may determine an accuracy of each of the trained AI models 360 based on the corresponding sets of features of the validation set. The validation engine 324 may discard a trained AI model 360 that has an accuracy that does not meet a threshold accuracy. In some embodiments, the selection engine 326 may be capable of selecting a trained AI model 360 that has an accuracy that meets a threshold accuracy. In some embodiments, the selection engine 326 may be capable of selecting the trained AI model 360 that has the highest accuracy of the trained AI models 360.

The testing engine 328 may be capable of testing a trained AI model 360 using a corresponding set of features of a testing set from training set generator 312. For example, a first trained AI model 360 that was trained using a first set of features of the training set may be tested using the first set of features of the testing set. The testing engine 328 may determine a trained AI model 360 that has the highest accuracy of all of the trained AI models based on the testing sets. In some embodiments, the testing engine 328 and/or one or more components of the predictive system 180 can use one or more of the following techniques to minimize the likelihood of the trained AI model 360 producing false negatives: cost-sensitive learning (e.g., assigning different costs to false positives and false negatives during training of the AI model 360, such that false negatives are associated with higher costs), tuning a decision threshold of the trained AI model 360 to achieve a desired balance between false positives and false negatives, ensemble methods (e.g., bagging, boosting, and/or stacking a set of AI models), feature engineering (e.g., providing the model with more discriminative features to better distinguish between false positives and false negatives), etc.

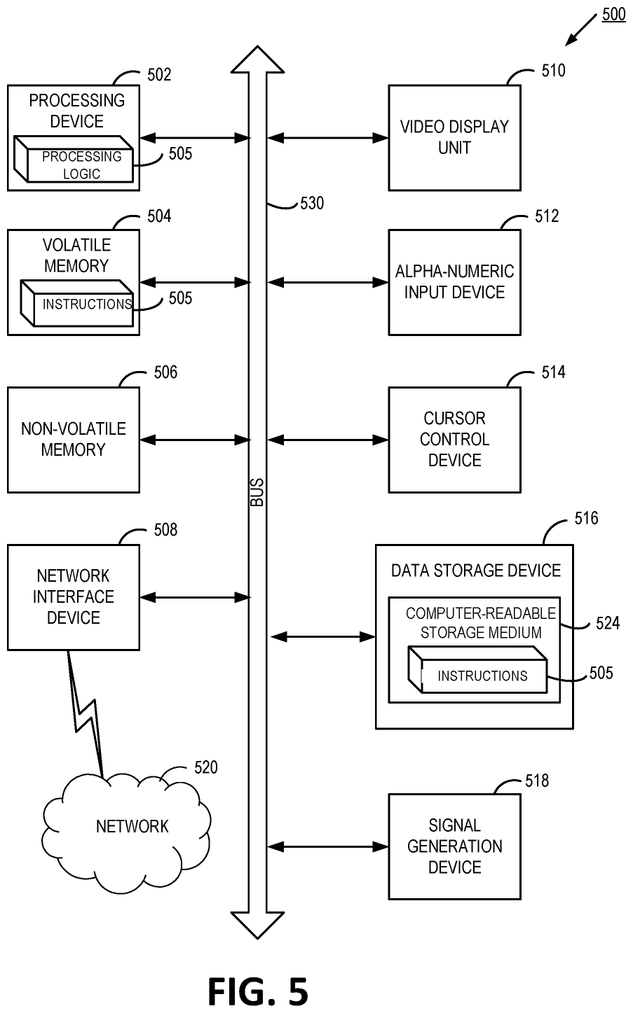

FIG. 5 is a block diagram illustrating an exemplary computer system 500, in accordance with implementations of the present disclosure. The computer system 500 can correspond to platform 120 and/or client devices 102A-N, described with respect to FIG. 1. Computer system 500 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 516, which communicate with each other via a bus 530.

Processor (processing device) 502 represents one or more general-purpose processing devices such as a microprocessor, central processing unit, or the like. More particularly, the processor 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 is configured to execute instructions 505 (e.g., detecting security threats) for performing the operations discussed herein.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 518 (e.g., a speaker).

The data storage device 516 can include a non-transitory machine-readable storage medium 524 (also computer-readable storage medium) on which is stored one or more sets of instructions 505 (e.g., detecting security threats) embodying any one or more of the methodologies or functions described herein. The instructions can also reside, completely or at least partially, within the main memory 504 and/or within the processor 502 during execution thereof by the computer system 500, the main memory 504 and the processor 502 also constituting machine-readable storage media. The instructions can further be transmitted or received over a network 520 via the network interface device 508.

In one implementation, the instructions 505 include instructions for detecting security threats. While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
receiving a plurality of records each corresponding to respective one or more events associated with a set of computing resources of one or more entities;
for each of the plurality of records, determining, using a trained artificial intelligence (AI) model, a level of confidence that a respective record is indicative of a security threat;
responsive to determining that a level of confidence of a first record of the plurality of records satisfies a first threshold criterion:
forwarding the first record to a security threat detection platform; and
responsive to determining that a level of confidence of each of a second record and a third record of the plurality of records fails to satisfy the first threshold criterion but satisfies a second threshold criterion:
aggregating the second record with the third record to create aggregated data; and
forwarding at least part of the aggregated data to the security threat detection platform.

2. The method of claim 1, wherein each of the plurality of records is received by a forwarder agent running on a computing resource of a respective set of computing resources.

3. The method of claim 1, wherein each of the plurality of records is received by a filtering component from a forwarder agent running on a computing resource of a respective set of computing resources.

4. The method of claim 1, wherein:
a level of confidence of a record satisfies the first threshold criterion when the level of confidence of the record is above a first threshold associated with the first threshold criterion; and
a level of confidence of a record satisfies the second threshold criterion when the level of confidence of the record is above a second threshold associated with the second threshold criterion, wherein the first threshold is higher than the second threshold.

5. The method of claim 1, wherein determining, using the trained AI model, the level of confidence that the respective record is indicative of the security threat comprises:
providing the respective record as input to the trained AI model; and
obtaining, from the trained AI model, one or more outputs specifying the level of confidence that the respective record is indicative of the security threat.

6. The method of claim 1, further comprising:
generating a training input based on a set of historical records of a plurality of historical events associated with a plurality of computing resources;
generating a target output for the first training input, wherein the first target output identifies whether each historical record of the plurality of historical records is indicative of a respective security threat; and
utilizing training data comprising the training input and the target output for re-training the trained AI model.

7. The method of claim 6, wherein generating the first training input further comprises:
splitting a historical record of the set of historical records into one or more tokens.

8. The method of claim 6, wherein generating the first training input further comprises:
transforming each token referenced in a historical record of the set of historical records into one or more stems.

9. The method of claim 6, wherein generating the first training input further comprises:
transforming each token referenced in a historical record of the set of historical records into one or more lemmas.

10. The method of claim 6, wherein generating the first training input further comprises:
discarding one or more tokens from a historical record of the set of historical records.

11. A system comprising:
a memory; and
a processing device coupled to the memory, the processing device to perform operations comprising:
receiving a plurality of records each corresponding to respective one or more events associated with a set of computing resources of one or more entities;
for each of the plurality of records, determining, using a trained artificial intelligence (AI) model, a level of confidence that a respective record is indicative of a security threat;
responsive to determining that a level of confidence of a first record of the plurality of records satisfies a first threshold criterion:
forwarding the first record to a security threat detection platform; and
responsive to determining that a level of confidence of each of a second record and a third record of the plurality of records fails to satisfy the first threshold criterion but satisfies a second threshold criterion:
aggregating the second record with the third record to create aggregated data; and
forwarding at least part of the aggregated data to the security threat detection platform.

12. The system of claim 11, wherein each of the plurality of records is received by a forwarder agent running on a computing resource of a respective set of computing resources.

13. The system of claim 11, wherein each of the plurality of records is received by a filtering component from a forwarder agent running on a computing resource of a respective set of computing resources.

14. The system of claim 11, wherein:
a level of confidence of a record satisfies the first threshold criterion when the level of confidence of the record is above a first threshold associated with the first threshold criterion; and
a level of confidence of a record satisfies the second threshold criterion when the level of confidence of the record is above a second threshold associated with the second threshold criterion, wherein the first threshold is higher than the second threshold.

15. The system of claim 11, wherein to determine, using the trained AI model, the level of confidence that the respective record is indicative of the security threat, the operating further comprise:
providing the respective record as input to the trained AI model; and
obtaining, from the trained AI model, one or more outputs specifying the level of confidence that the respective record is indicative of the security threat.

16. A non-transitory computer readable storage medium comprising instructions for a server that, when executed by a processing device, cause the processing device to perform operations comprising:
receiving a plurality of records each corresponding to respective one or more events associated with a set of computing resources of one or more entities;
for each of the plurality of records, determining, using a trained artificial intelligence (AI) model, a level of confidence that a respective record is indicative of a security threat;
responsive to determining that a level of confidence of a first record of the plurality of records satisfies a first threshold criterion:
forwarding the first record to a security threat detection platform; and
responsive to determining that a level of confidence of each of a second record and a third record of the plurality of records fails to satisfy the first threshold criterion but satisfies a second threshold criterion:
aggregating the second record with the third record to create aggregated data; and
forwarding at least part of the aggregated data to the security threat detection platform.

17. The non-transitory computer readable storage medium of claim 16, wherein each of the plurality of records is received by a forwarder agent running on a computing resource of a respective set of computing resources.

18. The non-transitory computer readable storage medium of claim 16, wherein each of the plurality of records is received by a filtering component from a forwarder agent running on a computing resource of a respective set of computing resources.

19. The non-transitory computer readable storage medium of claim 16, wherein:
a level of confidence of a record satisfies the first threshold criterion when the level of confidence of the record is above a first threshold associated with the first threshold criterion; and
a level of confidence of a record satisfies the second threshold criterion when the level of confidence of the record is above a second threshold associated with the second threshold criterion, wherein the first threshold is higher than the second threshold.

20. The non-transitory computer readable storage medium of claim 16, wherein to determine, using the trained AI model, the level of confidence that the respective record is indicative of the security threat, the operations further comprise:
providing the respective record as input to the trained AI model; and
obtaining, from the trained AI model, one or more outputs specifying the level of confidence that the respective record is indicative of the security threat.
